(19) United States
(12) Patent Application Publication
(10) Pub. No.: US 2011/0313125 A1
(43) Pub. Date: Dec. 22, 2011

(54) POLY(TRIMETHYLENE TEREPHTHALATE) PELLETS WITH REDUCED OLIGOMERS AND METHOD TO MEASURE OLIGOMER REDUCTION

(75) Inventors: Joseph V. Kurian, Hockessin, DE (US); Yuanfeng Liang, Chadds Ford, PA (US)

(73) Assignee: E. I. DU PONT DE NEMOURS AND COMPANY

(21) Appl. No.: 13/254,240

(22) PCT Filed: Mar. 2, 2010
(86) PCT No.: PCT/US10/25914

§ 371 Date: Sep. 1, 2011

(30) Foreign Application Priority Data
Mar. 3, 2009 (US) 61156944

(51) Int. Cl. C08G 63/90; B29C 47/00; C08G 63/183

(52) U.S. Cl. 528/308.6; 264/176.1

(57) ABSTRACT

The invention relates to the preparation of poly(trimethylene terephthalate) polymer pellets with reduced oligomers and a process for measuring the reduction of oligomers in PTT polymer which occurs when the polymer is subjected to a heat source. This reduction allows for lower polymer blooming due to reduction of oligomers in the polymer.

### FIELD OF THE INVENTION

This invention relates to a process for reducing oligomers and measuring the reduction of oligomers in poly(trimethylene terephthalate) polymer which occurs when the polymer is subjected to a heat source. This reduction allows for reduced blooming of the products due to reduction of oligomers in the polymer.

### BACKGROUND

The phenomenon of “blooming” is a common problem for polymeric materials. Incompatible materials added to polymers can migrate to the surface of the part, causing a “bloom” or “haze.” These defects have a negative effect on the cosmetic appearance of the material and sometimes can impact performance of the material. In polyester technology, blooming is a well researched phenomenon in poly(ethylene terephthalate) (PET) films and fibers. In the case of PET, the bloom is not from an additive, but a thermodynamic by-product formed during step polymerizations, generally cyclic oligomers, which exist at equilibrium with linear polymer chains during the melt polymerization process. A similar phenomenon is known to exist in melt processed poly(trimethylene terephthalate) (PTT). Molded articles of PTT containing a high amount of cyclic oligomers exhibit an oligomer bloom during high humidity, elevated temperature, and long-term stability tests.

Cyclic oligomers exist at equilibrium during the melt polymerization process of PTT, and are primarily cyclic dimers. Cyclic dimer comprise up to 90 percent of the cyclic oligomers in PTT polymer, and are generally present in amounts of about 2.8 weight percent based on the total weight of polymer plus oligomer.

Cyclic oligomers create problems during PTT polymerization, processing and in end-use applications, including injection molded parts, apparel fibers, filaments and films. The reduction of cyclic oligomer concentrations could enhance some properties of the polymer (e.g., surface gloss and appearance). Lowering cyclic oligomer concentrations could greatly impact polymer production, extend wipe cycle times during fiber spinning, oligomer blooming of injection molded parts, and blushing of films. Therefore there is a need for PTT with reduced oligomers and for a method to measure the oligomer reduction.

### SUMMARY OF THE INVENTION

The invention is directed to a process for reducing oligomer content of poly(trimethylene terephthalate) polymer pellets, comprising:

a. subjecting the poly(trimethylene terephthalate) polymer pellets to a heat source for a period of time;

b. performing a solvent extraction procedure on the poly(trimethylene terephthalate) polymer pellets whereby oligomer(s) is separated from the poly(trimethylene terephthalate) polymer pellets into an extraction solvent.

The process further comprising:

c. isolating said oligomer from said extraction solvent; and

d. isolating poly(trimethylene terephthalate) polymer pellets with reduced oligomer levels wherein the oligomer level in the polymer pellet is 0.05 to 2.2 weight %.

The invention is further directed to a process for measuring the reduction of oligomer content of poly(trimethylene terephthalate) polymer, comprising:

a. subjecting the poly(trimethylene terephthalate) polymer to a heat source for a period of time;

b. performing an extraction procedure on the poly(trimethylene terephthalate) polymer whereby oligomer(s) is separated from the poly(trimethylene terephthalate) polymer into an extraction solvent;

c. isolating said oligomer from said extraction solvent; and

d. measuring the amount of oligomer extracted from the poly(trimethylene terephthalate) polymer.

### DETAILS

Unless otherwise defined, all technical and scientific terms used herein have the same meaning as commonly understood by one of ordinary skill in the art to which this invention belongs. In case of conflict, the present specification, including definitions, will control.

Except where expressly noted, trademarks are shown in upper case.

Unless otherwise stated, all percentages, parts, ratios, etc., are by weight.

Resin Component

As indicated above, the resin component (and composition as a whole) comprises a predominant amount of a poly(trimethylene terephthalate).

Poly(trimethylene terephthalate) suitable for use in the invention are well known in the art, and conveniently prepared by polycondensation of 1,3-propanediol with terephthalic acid or terephthalic acid equivalent.

By “terephthalic acid equivalent” is meant compounds that perform substantially like terephthalic acids in reaction with polymeric glycols and diols, as would be generally recognized by a person of ordinary skill in the relevant art. Terephthalic acid equivalents for the purpose of the present invention include, for example, esters (such as dimethyl terephthalate), and ester-forming derivatives such as acid halides (e.g., acid chlorides) and anhydrides.

Preferred are terephthalic acid and terephthalic acid esters, more preferably the dimethyl ester. Methods for preparation of poly(trimethylene terephthalate) are discussed, for example in U.S. Pat. No. 6,277,947, U.S. Pat. No. 6,326,456, U.S. Pat. No. 6,657,044, U.S. Pat. No. 6,353,062, U.S. Pat. No. 6,538,076, US2003/0220465A1 and commonly owned U.S. patent application Ser. No. 11/638,919 (filed 14 Dec. 2006, entitled “Continuous Process for Producing Poly(trimethylene Terephthalate)”).

Poly(trimethylene terephthalate) polymer resins composition comprises poly(trimethylene terephthalate) repeat units and is in the form of pellets or flakes. A typical polymer pellet dimension is 4 mm×3 mm×3 mm and weighs 3.0-4.0 g/100 pellets. Initial poly(trimethylene terephthalate) polymer as manufactured has a cyclic oligomer composition of 2.5-3.0 weight % of which about 90% is the cyclic dimer. Poly(trimethylene terephthalate) polymer pellet has an initial intrinsic viscosity of 0.40-1.2 dL/g.

Specific process of making a poly(trimethylene terephthalate) polymer resin having low cyclic oligomer content consists essentially of providing an initial poly(trimethylene terephthalate) resin composition in the form of pellets or flakes and heating and agitating the pellets or flakes to a relatively higher temperature (>140 deg C.) for a select period of time to provide high intrinsic viscosity poly(trimethylene terephthalate) resin pellets with lower levels of cyclic oligomer content. Heating temperatures can be as high as 220 deg C., depending on the design of the heating unit and the desired final intrinsic viscosity. By this process, cyclic oligomers in polymer pellets can be reduced to levels as low as 0.05 weight %. It is also demonstrated that poly(trimethylene terephthalate) polymer pellets with reduced oligomer levels of about 0.05% to 2.2% can be prepared by the solvent extraction process.

The 1,3-propanediol for use in making the poly(trimethylene terephthalate) can be obtained from petrochemical sources as well as biochemical sources. It is preferably obtained biochemically from a renewable source (“biologically-derived” 1,3-propanediol).

A particularly preferred source of 1,3-propanediol is via a fermentation process using a renewable biological source. As an illustrative example of a starting material from a renewable source, biochemical routes to 1,3-propanediol (PDO) have been described that utilize feedstocks produced from biological and renewable resources such as corn feed stock. For example, bacterial strains able to convert glycerol into 1,3-propanediol are found in the species Klebsiella, Citrobacter, Clostridium, and Lactobacillus. The technique is disclosed in several publications, including previously incorporated U.S. Pat. No. 5,633,362, U.S. Pat. No. 5,686,276 and U.S. Pat. No. 5,821,092. U.S. Pat. No. 5,821,092 discloses, inter alia, a process for the biological production of 1,3-propanediol from glycerol using recombinant organisms. The process incorporates E. coli bacteria, transformed with a heterologous pdu diol dehydratase gene, having specificity for 1,2-propanediol. The transformed E. coli is grown in the presence of glycerol as a carbon source and 1,3-propanediol is isolated from the growth media. Since both bacteria and yeasts can convert glucose (e.g., corn sugar) or other carbohydrates to glycerol, the processes disclosed in these publications provide a rapid, inexpensive and environmentally responsible source of 1,3-propanediol monomer.

The biologically-derived 1,3-propanediol, such as produced by the processes described and referenced above, contains carbon from the atmospheric carbon dioxide incorporated by plants, which compose the feedstock for the production of the 1,3-propanediol. In this way, the biologically-derived 1,3-propanediol preferred for use in the context of the present invention contains only renewable carbon, and not fossil fuel-based or petroleum-based carbon. The poly(trimethylene terephthalate) based thereon utilizing the biologically-derived 1,3-propanediol, therefore, has less impact on the environment as the 1,3-propanediol used does not deplete diminishing fossil fuels and, upon degradation, releases carbon back to the atmosphere for use by plants once again. Thus, the compositions of the present invention can be characterized as more natural and having less environmental impact than similar compositions comprising petroleum based diols.

The biologically-derived 1,3-propanediol, and poly(trimethylene terephthalate) based thereon, may be distinguished from similar compounds produced from a petrochemical source or from fossil fuel carbon by dual carbon-isotopic finger printing. This method usefully distinguishes chemically-identical materials, and apportions carbon material by source (and possibly year) of growth of the biospheric (plant) component. The isotopes, ¹⁴C and ¹³C, bring complementary information. The radiocarbon dating isotope (¹⁴C), with its nuclear half life of 5730 years, clearly allows one to apportion specimen carbon between fossil (“dead”) and biospheric (“alive”) feedstocks (Currie, L. A. “Source Apportionment of Atmospheric Particles,” Characterization of Environmental Particles, J. Buffle and H. P. van Leeuwen, Eds., 1 of Vol. I of the IUPAC Environmental Analytical Chemistry Series (Lewis Publishers, Inc) (1992) 3-74). The basic assumption in radiocarbon dating is that the constancy of ¹⁴C concentration in the atmosphere leads to the constancy of ¹⁴C in living organisms. When dealing with an isolated sample, the age of a sample can be deduced approximately by the relationship:

t=(−5730/0.693)ln(A/A₀)

wherein t=age, 5730 years is the half-life of radiocarbon, and A and A₀ are the specific ¹⁴C activity of the sample and of the modern standard, respectively (Hsieh, Y., Soil Sci. Soc. Am J., 56, 460, (1992)). However, because of atmospheric nuclear testing since 1950 and the burning of fossil fuel since 1850, ¹⁴C has acquired a second, geochemical time characteristic. Its concentration in atmospheric CO₂, and hence in the living biosphere, approximately doubled at the peak of nuclear testing, in the mid-1960s. It has since been gradually returning to the steady-state cosmogenic (atmospheric) baseline isotope rate (¹⁴C/¹²C) of ca. 1.2×10⁻¹², with an approximate relaxation “half-life” of 7-10 years. (This latter half-life must not be taken literally; rather, one must use the detailed atmospheric nuclear input/decay function to trace the variation of atmospheric and biospheric ¹⁴C since the onset of the nuclear age.) It is this latter biospheric ¹⁴C time characteristic that holds out the promise of annual dating of recent biospheric carbon. ¹⁴C can be measured by accelerator mass spectrometry (AMS), with results given in units of “fraction of modern carbon” (f_{M}). f_{M} is defined by National Institute of Standards and Technology (NIST) Standard Reference Materials (SRMs) 4990B and 4990C, known as oxalic acids standards HOxI and HOxII, respectively. The fundamental definition relates to 0.95 times the ¹⁴C/¹²C isotope ratio HOxI (referenced to AD 1950). This is roughly equivalent to decay-corrected pre-Industrial Revolution wood. For the current living biosphere (plant material), f_{M}≈1.1.

The stable carbon isotope ratio (¹³C/¹²C) provides a complementary route to source discrimination and apportionment. The ¹³C/¹²C ratio in a given biosourced material is a consequence of the ¹³C/¹²C ratio in atmospheric carbon dioxide at the time the carbon dioxide is fixed and also reflects the precise metabolic pathway. Regional variations also occur. Petroleum, C₃ plants (the broadleaf), C₄ plants (the grasses), and marine carbonates all show significant differences in ¹³C/¹²C and the corresponding δ ¹³C values. Furthermore, lipid matter of C₃ and C₄ plants analyze differently than materials derived from the carbohydrate components of the same plants as a consequence of the metabolic pathway. Within the precision of measurement, ¹³C shows large variations due to isotopic fractionation effects, the most significant of which for the instant invention is the photosynthetic mechanism. The major cause of differences in the carbon isotope ratio in plants is closely associated with differences in the pathway of photosynthetic carbon metabolism in the plants, particularly the reaction occurring during the primary carboxylation, i.e., the initial fixation of atmospheric CO₂. Two large classes of vegetation are those that incorporate the “C₃” (or Calvin-Benson) photosynthetic cycle and those that incorporate the “C₄” (or Hatch-Slack) photosynthetic cycle. C₃ plants, such as hardwoods and conifers, are dominant in the temperate climate zones. In C₃ plants, the primary CO₂ fixation or carboxylation reaction involves the enzyme ribulose-1,5-diphosphate carboxylase and the first stable product is a 3-carbon compound. C₄ plants, on the other hand, include such plants as tropical grasses, corn and sugar cane. In C₄ plants, an additional carboxylation reaction involving another enzyme, phosphenol-pyruvate carboxylase, is the primary carboxylation reaction. The first stable carbon compound is a 4-carbon acid, which is subsequently decarboxylated. The CO₂ thus released is refixed by the C₃ cycle.

Both C₄ and C₃ plants exhibit a range of ¹³C/¹²C isotopic ratios, but typical values are ca. −10 to −14 per mil (C₄) and −21 to −26 per mil (C₃) (Weber et al., J. Agric. Food Chem., 45, 2042 (1997)). Coal and petroleum fall generally in this latter range. The ¹³C measurement scale was originally defined by a zero set by pee dee belemnite (PDB) limestone, where values are given in parts per thousand deviations from this material. The “δ¹³C” values are in parts per thousand (per mil), abbreviated ‰, and are calculated as follows:

$$δ {}^{13} C ≡ \frac{( {}^{13} C / {}^{12} C ) sample - ( {}^{13} C / {}^{12} C ) standard}{( {}^{13} C / {}^{12} C ) standard} \times 1000 \% o$$

Since the PDB reference material (RM) has been exhausted, a series of alternative RMs have been developed in cooperation with the IAEA, USGS, NIST, and other selected international isotope laboratories. Notations for the per mil deviations from PDB is δ¹³C. Measurements are made on CO₂ by high precision stable ratio mass spectrometry (IRMS) on molecular ions of masses 44, 45 and 46.

Biologically-derived 1,3-propanediol, and compositions comprising biologically-derived 1,3-propanediol, therefore, may be completely distinguished from their petrochemical derived counterparts on the basis of ¹⁴C (f_{M}) and dual carbon-isotopic fingerprinting, indicating new compositions of matter. The ability to distinguish these products is beneficial in tracking these materials in commerce. For example, products comprising both “new” and “old” carbon isotope profiles may be distinguished from products made only of “old” materials. Hence, the instant materials may be followed in commerce on the basis of their unique profile and for the purposes of defining competition, for determining shelf life, and especially for assessing environmental impact.

Preferably the 1,3-propanediol used as a reactant or as a component of the reactant in making poly(trimethylene terephthalate) will have a purity of greater than about 99%, and more preferably greater than about 99.9%, by weight as determined by gas chromatographic analysis. Particularly preferred are the purified 1,3-propanediols as disclosed in U.S. Pat. No. 7,038,092, U.S. Pat. No. 7,098,368, U.S. Pat. No. 7,084,311 and US20050069997A1.

The purified 1,3-propanediol preferably has the following characteristics:

(1) an ultraviolet absorption at 220 nm of less than about 0.200, and at 250 nm of less than about 0.075, and at 275 nm of less than about 0.075; and/or

(2) a composition having a CIELAB “b*” color value of less than about 0.15 (ASTM D6290), and an absorbance at 270 nm of less than about 0.075; and/or

(3) a peroxide composition of less than about 10 ppm; and/or

(4) a concentration of total organic impurities (organic compounds other than 1,3-propanediol) of less than about 400 ppm, more preferably less than about 300 ppm, and still more preferably less than about 150 ppm, as measured by gas chromatography.

Poly(trimethylene terephthalate)s useful in this invention can be poly(trimethylene terephthalate) homopolymers (derived substantially from 1,3-propane diol and terephthalic acid and/or equivalent) and copolymers, by themselves or in blends. Poly(trimethylene terephthalate)s used in the invention preferably contain about 70 mole % or more of repeat units derived from 1,3-propane diol and terephthalic acid (and/or an equivalent thereof, such as dimethyl terephthalate).

The poly(trimethylene terephthalate) may contain up to 30 mole % of repeat units made from other diols or diacids. The other diacids include, for example, isophthalic acid, 1,4-cyclohexane dicarboxylic acid, 2,6-naphthalene dicarboxylic acid, 1,3-cyclohexane dicarboxylic acid, succinic acid, glutaric acid, adipic acid, sebacic acid, 1,12-dodecane dioic acid, and the derivatives thereof such as the dimethyl, diethyl, or dipropyl esters of these dicarboxylic acids. The other diols include ethylene glycol, 1,4-butane diol, 1,2-propanediol, diethylene glycol, triethylene glycol, 1,3-butane diol, 1,5-pentane diol, 1,6-hexane diol, 1,2-, 1,3- and 1,4-cyclohexane dimethanol, and the longer chain diols and polyols made by the reaction product of diols or polyols with alkylene oxides.

Poly(trimethylene terephthalate) polymers useful in the present invention may also include functional monomers, for example, up to about 5 mole % of sulfonate compounds useful for imparting cationic dyeability. Specific examples of preferred sulfonate compounds include 5-lithium sulfoisophthalate, 5-sodium sulfoisophthalate, 5-potassium sulfoisophthalate, 4-sodium sulfo-2,6-naphthalenedicarboxylate, tetramethylphosphonium 3,5-dicarboxybenzene sulfonate, tetrabutylphosphonium 3,5-dicarboxybenzene sulfonate, tributyl-methylphosphonium 3,5-dicarboxybenzene sulfonate, tetrabutylphosphonium 2,6-dicarboxynaphthalene-4-sulfonate, tetramethylphosphonium 2,6-dicarboxynapthalene-4-sulfonate, ammonium 3,5-dicarboxybenzene sulfonate, and ester derivatives thereof such as methyl, dimethyl, and the like.

More preferably, the poly(trimethylene terephthalate)s contain at least about 80 mole %, or at least about 90 mole %, or at least about 95 mole %, or at least about 99 mole %, of repeat units derived from 1,3-propanediol and terephthalic acid (or equivalent). The most preferred polymer is poly(trimethylene terephthalate) homopolymer (polymer of substantially only 1,3-propane diol and terephthalic acid or equivalent).

The resin component may contain other polymers blended with the poly(trimethylene terephthalate) such as poly(ethylene terephthalate) (PET), poly(butylene terephthalate) (PBT), poly(ethylene) (PE), poly(styrene) (PS), a nylon such nylon-6 and/or nylon-6,6, etc., and preferably contains at least about 70 wt %, or at least about 80 wt %, or at least about 90 wt %, or at least about 95 wt %, or at least about 99 wt %, poly(trimethylene terephthalate) based on the weight of the resin component. In one preferred embodiment of this patent, the polyester resin comprises 90-100 wt % of poly(trimethylene terephthalate) polyester.

### Additive Package

The poly(trimethylene terephthalate)-based compositions of the present invention may contain additives such as antioxidants, residual catalyst, delusterants (such as TiO₂, zinc sulfide or zinc oxide), colorants (such as dyes), stabilizers, fillers (such as calcium carbonate), antimicrobial agents, antistatic agents, optical brighteners, extenders, processing aids and other functional additives, hereinafter referred to as “chip additives”. When used, TiO₂ or similar compounds (such as zinc sulfide and zinc oxide) are used as pigments or delusterants in amounts normally used in making poly(trimethylene terephthalate) compositions, that is up to about 5 wt % or more (based on total composition weight) in making fibers and larger amounts in some other end uses.

By “pigment” reference is made to those substances commonly referred to as pigments in the art. Pigments are substances, usually in the form of a dry powder, that impart color to the polymer or article (e.g., chip or fiber). Pigments can be inorganic or organic, and can be natural or synthetic. Generally, pigments are inert (e.g., electronically neutral and do not react with the polymer) and are insoluble or relatively insoluble in the medium to which they are added, in this case the poly(trimethylene terephthalate) composition. In some instances they can be soluble.

Low concentrations of these additives (0-5%) have not been found to positively impact part blooming. The methods covered in the present disclosure can be applied to PTT parts containing these additive packages, glass fibers or mineral fillers.

In the present embodiments, poly(trimethylene terephthalate) polymer is subjected to a heat source, including but not limited to an oven or column or rotating dryer. Various types of dryers can be used including column and rotating dryers. In the examples below, the dryer used was a tumble dryer with a capacity of about 200 pounds (identified as a P-200 dryer). The polymer is heated at temperatures between about 110 degrees Celsius and 220 degrees Celsius, for time periods between about 2 hours and 48 hours. For SPP conditions (example 8), a tumble dryer with a size of 10 m³ and a capacity of 6 tons, was operated at 212° C. This exposure to heat decreases the amount of oligomer in the polymer, which can then be quantified by various analytical methods. A particularly useful method to quantify the reduction in oligomer is Soxhlet extraction, because of the simplicity of the technique. Soxhlet extraction is widely used in the polymer industry to quantify oligomers and polymer additives. NMR is another method that can be used to quantify the amount of cyclic oligomer present in the polymer.

### Soxhlet Extraction

The present embodiments employ Soxhlet extraction to extract and quantify the amount of oligomers in the poly(trimethylene terephthalate) polymer pellets.

In this method, solid pellets (0.033 g/pellet) of poly(trimethylene terephthalate) are placed inside a thimble, which has been weighed to provide a tare weight. Generally, a thimble is made from filter media, and it is then loaded into the main chamber of a Soxhlet extractor. The Soxhlet extractor is then placed onto a flask containing the extraction solvent. For the embodiments included herein, methylene chloride (CH₂Cl₂) is used as the solvent, although other solvents could also be used. For the oligomer separation and quantification in PTT pellets, methylene chloride is the preferred solvent. Other organic solvents for extraction may include methanol, ethanol, isopropanol, acetone, acetonitrile, ethyl acetate, ethyl ether, THF, petroleum ether, toluene, xylene, etc). The Soxhlet extractor is then equipped with a condenser.

The solvent is heated to reflux. The solvent vapor travels up a distillation arm, and floods into the chamber housing the thimble of solid poly(trimethylene terephthalate). The condenser ensures that any solvent vapor cools, and drips back down into the chamber housing the solid poly(trimethylene terephthalate).

The chamber containing the solid poly(trimethylene terephthalate) slowly fills with warm solvent. Some of the desired oligomeric compounds will then dissolve in the warm solvent. When the Soxhlet chamber is almost full, the chamber is automatically emptied by a siphon side arm, with the solvent running back down to the distillation flask. This cycle can repeat many times, over hours or days. In the present examples, extraction was generally done over a 24 hour period.

During each cycle, a portion of the non-volatile oligomeric compounds dissolves in the solvent. After many cycles the desired compound is concentrated in the distillation flask. The advantage of this system is that instead of many portions of warm solvent being passed through the sample, just one batch of solvent is recycled.

After extraction the solvent is removed, typically by means of a rotary evaporator, yielding the extracted oligomeric compounds. The non-soluble portion of the extracted solid remains in the thimble, and then is weighed, with the amount of oligomeric compound calculated by weight difference, and generally reported as weight percent based on the total weight of the polymer and oligomeric materials.

Poly(trimethylene terephthalate)s useful as the polyester in this invention are commercially available from E. I. DuPont de Nemours and Company of Wilmington, Del. under the trademark Sorona® and from Shell Chemicals of Houston, Tex. under the trademark Corterra®. These materials are available in a variety of IV's (intrinsic viscosities).

All other chemicals and reagents were used as received from Sigma-Aldrich Company, Milwaukee, Wis.

### Examples

General procedure for Soxhlet extraction for Poly(trimethylene terephthalate) oligomers There are ASTM methods for determining additives and extractables in plastics. For example, refer to ASTM D5227-95 and ASTM D7210. The Soxhlet extraction method used herein shows the difference in polymer properties and solubility of oligomers. In the examples below, to a Ahlstrom extraction thimble (Ahlstrom 7100 Cellulose Extraction Thimble, 43×123 mm) was added 20 g of poly(trimethylene terephthalate) polymer pellets (pellet dimension: 3 mm×3 mm×4 mm), weighed using an analytical balance (up to 4^{th} decimal precision), and this thimble was then placed onto a 500 ml round bottom flask, to which 300 mL of methylene chloride (CH₂Cl₂) was added. The flask was heated and refluxed, and then extracted with CH₂Cl₂ for 24 hours. The contents of the round bottom flask were dried with a rotary evaporator and the extracted oligomers were collected from the flask, dried and weighed. The weight difference was quantified and the total amount of oligomer residue was reported as a percentage.

The following examples illustrate the process as described above to reduce the amount of oligomer levels in poly(trimethylene terephthalate) polymer pellets. In Table 1 below, the term “CP” refers to “continuous polymerizer”.

TABLE 1
Soxhlet Extraction
(with CH₂Cl₂ for 24 hrs.)

| | | | Heating | Heating | Extracted | |
|---|---|---|---|---|---|---|
| | Polymer | Starting | Temperature | Time | Oligomers | |
| | Details | IV (dL/g) | (° C.) | (hours) | (%) | Comment |
| Example | Amorphous | 1.02 | none | none | 2.70 | Control |
| 1 | CP polymer | | | | | |
| | pellets | | | | | |
| Example | Amorphous | 1.02 | 140 | 16 | 0.90 | Drying |
| 2 | CP polymer | | | | | performed in |
| | pellets | | | | | an air oven |
| Example | Amorphous | 1.02 | 140 | 24 | 0.55 | Drying |
| 3 | CP polymer | | | | | performed in |
| | pellets | | | | | an air oven |
| Example | Amorphous | 0.933 | 170 | 4 | 0.60 | Drying in a |
| 4 | batch | | | | | rotary dryer |
| | produced | | | | | (P-200) |
| | polymer | | | | | |
| | pellets | | | | | |
| Example | Amorphous | 1.02 | 180 | 4 | 0.50 | Drying |
| 5 | CP polymer | | | | | performed in |
| | pellets | | | | | an air oven |
| Example | Amorphous | 1.02 | 180 | 7 | 0.35 | Drying |
| 6 | CP polymer | | | | | performed in |
| | pellets | | | | | an air oven |
| Example | Amorphous | 1.02 | 180 | 24 | 0.30 | Drying |
| 7 | CP polymer | | | | | performed in |
| | pellets | | | | | an air oven |
| Example | Crystallized | 1.04 | 205 | 36 | 0.20 | Drying in a |
| 8 | batch | | | | | commercial |
| | polymer | | | | | scale rotary |
| | pellets | | | | | dryer |

As illustrated by the examples above, after poly(trimethylene terephthalate) polymer pellets were heated at various periods of time and temperatures as given in the Table 1, the amount of oligomers reduced significantly in Examples 2 through 8 as compared to the one without heat treatment (Example 1).

What is claimed is:

1. A process for reducing oligomer content of poly(trimethylene terephthalate) polymer pellets, comprising:
a. subjecting the poly(trimethylene terephthalate) polymer pellets to a heat source for a period of time;
b. performing a solvent extraction procedure on the poly(trimethylene terephthalate) polymer pellets whereby oligomer(s) is separated from the poly(trimethylene terephthalate) polymer pellets into an extraction solvent.

2. The process of claim 1 further comprising:
c. isolating said oligomer from said extraction solvent; and
d. isolating poly(trimethylene terephthalate) polymer pellets with reduced oligomer levels wherein the oligomer level in the polymer pellet is 0.05 to 2.2 weight %.

3. The process for measuring the reduction of oligomer content of poly(trimethylene terephthalate) polymer comprising:
a. subjecting the poly(trimethylene terephthalate) polymer to a heat source for a period of time;
b. performing an extraction procedure on the poly(trimethylene terephthalate) polymer whereby oligomer(s) is separated from the poly(trimethylene terephthalate) polymer into an extraction solvent;
c. isolating said oligomer from said extraction solvent; and
d. measuring the amount of oligomer extracted from the poly(trimethylene terephthalate) polymer.

4. The process of claim 1, wherein said heat source is an oven, a column dryer, or a rotating dryer.

5. The process of claim 3, wherein said heat source is an oven, a column dryer, or a rotating dryer.

6. The process of claim 1, wherein said period of heating time is between 2 and 48 hours.

7. The process of claim 3, wherein said period of heating time is between 2 and 48 hours.

8. The process of claim 1 wherein said heat source provides a temperature between 110-220 C.

9. The process of claim 3 wherein said heat source provides a temperature between 110-220 C.

10. The process of claim 1 wherein said extraction solvent is methylene chloride.

11. The process of claim 3 wherein said extraction solvent is methylene chloride.

12. Pellets comprising poly(trimethylene terephthalate) having 0.05 to 2.2 weight % oligomer level content as measured by Soxhlet extraction.

13. The pellets of claim 12 further comprising glass fibers or mineral fillers.

14. An article produced by molding pellets of claim 12 wherein said article exhibits reduced surface blooming.

15. Fiber produced by melt spinning pellets of claim 12.
